(19) United States
(12) Patent Application Publication
(10) Pub. No.: US 2014/0245281 A1
(43) Pub. Date: Aug. 28, 2014

(54) APPARATUS AND METHOD FOR PROVIDING APPLICATION IN PORTABLE TERMINAL

(71) Applicant: Samsung Electronics Co., Ltd., Gyeonggi-do (KR)

(72) Inventors: Byoung-Yong LEE, Seoul (KR); Sang-Don KIM, Gyeonggi-do (KR); Young-Chool KIM, Seoul (KR); Yoo-Ra KIM, Gyeonggi-do (KR); Ho-Sam KIM, Gyeonggi-do (KR); Joong-Hee MOON, Gyeonggi-do (KR); Dong-Hee SUH, Gyeonggi-do (KR); Gyung-Hun JANG, Gyeonggi-do (KR); Young-Bin CHO, Gyeonggi-do (KR); Hyun-Wook CHO, Daegu (KR); Ha-Young CHOI, Seoul (KR)

(73) Assignee: Samsung Electronics Co., Ltd., Gyeonggi-do (KR)

(21) Appl. No.: 14/191,721

(22) Filed: Feb. 27, 2014

(30) Foreign Application Priority Data
Feb. 27, 2013 (KR) 10-2013-0021410

(51) Int. Cl. G06F 9/445

(52) U.S. Cl. CPC G06F 8/65
USPC 717/171

(57) ABSTRACT

An apparatus and method for providing an application in a portable terminal is provided. The method includes receiving an identifier that represents a screen configuration of a particular application from a server that corresponds to the portable terminal; selecting a sample screen from among a plurality of sample screens provided by the particular application based on the received identifier; and configuring a screen of the particular application based on the selected sample screen.

### CLAIM OF PRIORITY

This application claims the benefit of priority under 35 U.S.C. §119(a) of a Korean Patent Application filed in the Korean Intellectual Property Office on Feb. 27, 2013, and assigned Serial No. 10-2013-0021410, the entire disclosure of which is incorporated herein by reference, in its entirety.

### TECHNICAL FIELD

The present disclosure generally relates to portable terminals. More particularly, the present disclosure relates to an apparatus and method for providing an application in a portable terminal.

### BACKGROUND

Nowadays, electronic devices such as portable terminals, which include but are not limited to smart phones, tablets, phablets, etc., provide users with various useful functionalities via many different applications. With the increase in the provision of various functionalities, the portable terminals are on a trend toward being viewed as computing devices that can use different forms of information as well as provide the voice call functionality. Especially, the portable terminal can provide information regarding a particular product to the user by running a particular application related to the particular product.

In this case, the particular application provides only a fixed single screen configuration to the user. Further, the particular application provides the same screen configuration for different manufacturers of the particular product. However, each manufacturer is likely to want to provide their own unique screen configuration to the user to advertise that they provide the particular product. Such a manufacturer's demand cannot be satisfied with provision of the same screen configuration.

Therefore, a need in the art exists for a way to provide a different screen configuration for each manufacturer.

The above information is presented as background information only to assist with an understanding of the present disclosure. No determination has been made, and no assertion is made, as to whether any of the above might be applicable as prior art with regard to the present invention.

### SUMMARY

The present invention includes an apparatus and method for providing an application in a portable terminal that permits a different screen configuration for each manufacturer of such portable terminals.

The present invention also includes an apparatus and method for providing an application in a portable terminal to permits a different screen configuration for each manufacturer using an identifier of a screen configuration preferred by the manufacturer.

In accordance with an aspect of the present invention, an apparatus for providing an application in a portable terminal includes: a Radio Frequency (RF) unit; and a controller for receiving an identifier that represents a screen configuration of a particular application from a server that corresponds to the portable terminal through the RF unit. The controller determines a selection of a sample screen made from among a plurality of sample screens provided by the particular application based on the received identifier, and controls the configuring a screen of the particular application based on the selected sample screen.

In accordance with another aspect of the present invention, a method for providing an application in a portable terminal, the method includes: receiving an identifier that represents a screen configuration of a particular application from a server that corresponds to the portable terminal; selecting a sample screen from among a plurality of sample screens provided by the particular application based on the received identifier; and configuring a screen of the particular application based on the selected sample screen.

Other aspects, advantages, and salient features of the invention will become better appreciated to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be better appreciated by an artisan from the following description taken in conjunction with the accompanying drawings in which:

FIG. 1 is a schematic diagram of a communication system, according to an exemplary embodiment of the invention;

FIG. 2 is a block diagram of a portable terminal, according to an exemplary embodiment of the present invention;

FIG. 3 illustrates a sequence of installing a particular application in a communication system, according to an exemplary embodiment of the invention;

FIG. 4 is a flowchart illustrating operation of a method of installing a particular application in a portable terminal, according to an exemplary embodiment of the invention;

FIG. 5A and FIG. 5B illustrate a sequence of re-installing a particular application in a communication system, according to an exemplary embodiment of the invention;

FIG. 6A and FIG. 6B are flowcharts illustrating operation of a method of re-installing a particular application in a portable terminal, according to an exemplary embodiment of the invention; and

FIG. 7A, FIG. 7B and FIG. 7C illustrate running screens of a particular application in a portable terminal, according to an exemplary embodiment of the invention.

Throughout the drawings, like reference numerals will be understood to refer to like parts, components, and structures.

### DETAILED DESCRIPTION

The following description with reference to the accompanying drawings is provided to assist a person of ordinary skill in the art with a comprehensive understanding of the invention. The description includes various specific details to assist in that understanding but these are to be regarded as merely exemplary for illustrative purposes. Accordingly, those of ordinary skill in the art will recognize that various changes and modifications of the embodiments described herein can be made without departing from the invention.

In addition, descriptions of well-known functions and constructions may be omitted for clarity and conciseness when their inclusion may obscure an artisan's appreciation of the subject matter of the present invention.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural references unless the context clearly dictates otherwise. Thus, for example, a reference to “a component surface” includes reference to one or more of such surfaces.

The portable terminal according to an embodiment of the present invention can be realized as a mobile electronic device that is easily carried by humans, and may include video phones, cellular phones, smart phones, International Mobile Telecommunication-2000 (IM-2000) terminals, Wideband Code Division Multiple Access (WCDMA) terminals, Universal Mobile Telecommunication Service (UMTS) terminals, Personal Digital Assistants (PDAs), Portable Multimedia Players (PMPs), Digital Multimedia Broadcasting (DMB) terminals, E-Books, portable computers (e.g., laptops, tablet Personal Computers (PCs), etc.), or digital cameras, etc.

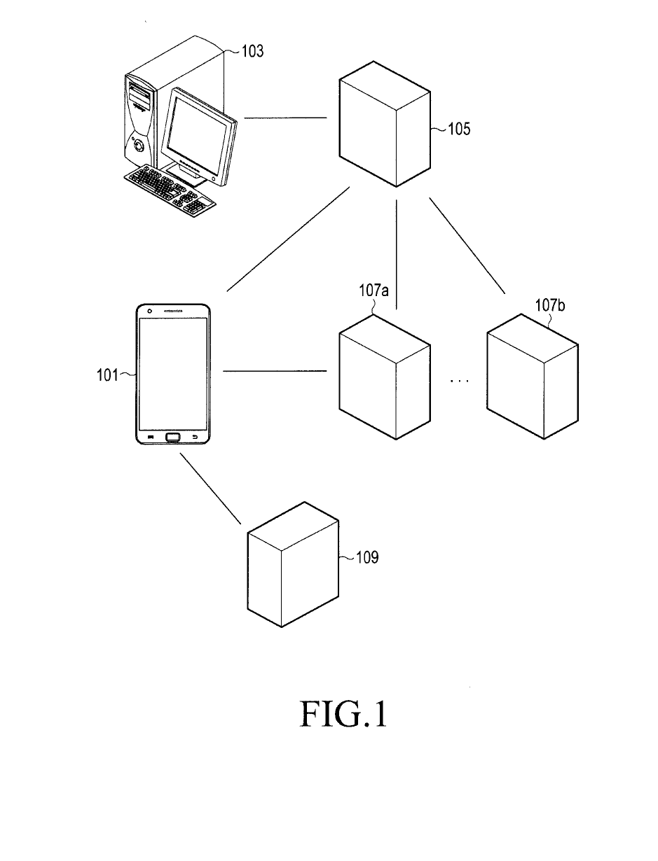

FIG. 1 is a schematic diagram of a communication system, according to an exemplary embodiment of the invention.

Referring now to FIG. 1, the communication system may include a portable terminal 101, a terminal 103, a service server 105, a plurality of customer servers 107a and 107b, and a download server 109. An artisan should understand and appreciate that his configuration is provided only for illustrative purposes and does not limit the claimed invention.

The service server 105 offers the portable terminal 101 services provided by the plurality of customer servers 107a and 107b. Especially, the service server 105 provides the portable terminal 101 with a particular application for an installation in the portable terminal 101 by exchanging data related to the particular application with the plurality of customer servers 107a and 107b, the terminal 103, and the portable terminal 101.

More specifically, at a service manager's request for registration of a customer, the service server 105 provides a storage and may create a database for storing data related to the customer and registers the customer by creating the customer's identity (ID) to later identify the customer. When any one of a plurality of service items that may be provided by the service manager to the customer is selected, the service server 105 determines how to provide a service that corresponds to the selected service item. The plurality of service items include, for example, Driving Experience (DE) and Smart Driving (SD). DE is a service that provides driving guides, application's manual, gallery, announcements, news, magazine, etc. through a particular application, and SD is a service that provides driving-related information including a self recording function of driving record. The service server 105 sends a content registration request message to request content registration to one of the plurality of customer servers 107a and 107b that corresponds to the registered customer.

The service server 105 also stores customer IDs, Internet addresses, e.g., Uniform Resource Locators (URLs) for connecting to corresponding customer servers, and at least one portable terminal's ID for each registered customer. For example, where there are a plurality customer servers corresponding to registered customers, e.g., 107a and 107b, the service server 105 may create a database that lists Internet addresses of the customer servers 107a and 107b and at least one portable terminal's ID, as shown in Table 1.

TABLE 1

| | | Portable |
|---|---|---|
| Customer ID | Internet Address | Terminal's ID |
| xx | www.xxx.xxx | aaa |
| | | bbb |
| yy | www.yyy.yyy | ccc |
| | | ddd |

With regard to the above table, xx represents a customer ID that corresponds to the customer server 107a, www.xxx.xxx represents an Internet address with which to connect to the customer server 107a, aaa and bbb are respective portable terminal IDs associated with the customer server 107a. In addition, yy represents a customer ID that corresponds to the customer server 107b, www.yyy.yyy represents an Internet address with which to connect to the customer server 107b, ccc and ddd are respective portable terminal IDs associated with the customer server 107b.

The service server 105 may also receive from the portable terminal 101 a first authentication request message to request authentication. The first authentication request message includes the portable terminal's 101 ID and a customer ID that corresponds to the portable terminal 101. The portable terminal's 101 ID may be, for example, a Media Access Control (MAC) address of the portable terminal 101. The service server 105 analyzes the first authentication request message to detect the portable terminal's 101 ID and the customer ID, and that authenticates the portable terminal 101 using the portable terminal's 101 ID and the customer ID. Specifically, the service server 105 searches its database as shown in Table 1 for at least one portable terminal's ID that corresponds to the detected customer ID, and determines whether there is any of the at least one searched portable terminal's ID which is identical to the detected portable terminal's 101 ID.

If the service server 105 determines that there is a portable terminal's ID in the database which is identical to the portable terminal's 101 ID, the service server 105 creates a first authentication reply message that represents successful authentication and transmits it to the portable terminal 101. Otherwise, if the service server 105 determines that there is no portable terminal's ID identical to the portable terminal's 101 ID, the service server 105 creates a second authentication reply message that represents authentication failure and transmits it to the portable terminal 101.

Furthermore, the service server 105 enables the portable terminal 101 to re-install a particular application by transmitting to the portable terminal 101 an Internet address of a customer server that is associated with the portable terminal 101 in need of re-installing the particular application.

More specifically, the service server 105 may receive from the portable terminal 101 a second authentication request message to request authentication about the portable terminal 101. The second authentication request message includes the portable terminal's 101 ID. The portable terminal's 101 ID may be, for example, a MAC address of the portable terminal 101. The service server 105 analyzes the second authentication request message to detect the portable terminal's 101 ID, and authenticates the portable terminal 101 using the portable terminal's 101 ID. The service server 105 searches the database as shown in Table 1 for at least one portable terminal's ID, and determines whether or not there is a portable terminal's ID identical to the detected portable terminal's 100 ID.

If the service server 105 determines that there is a portable terminal's ID identical to the portable terminal's 101 ID, the service server 105 creates a first authentication reply message that represents successful authentication and transmits it to the portable terminal 101. Otherwise, if it is determined that there is no portable terminal's ID identical to the portable terminal's 101 ID, the service server 105 creates a second authentication reply message that represents authentication failure and transmits it to the portable terminal 101.

The service server 105 may then receive a service URL request message from the portable terminal 101. The service URL request message is a message to request a URL of a customer server associated with the portable terminal 101. The service server 105 detects an Internet address of the customer server associated with the portable terminal 101 using the database as shown in Table 1, and creates a service URL reply message that includes the Internet address of the customer server and transmits it to the portable terminal 101.

With continued reference to FIG. 1, the plurality of customer servers 107a and 107b each offer a service to the portable terminal 101. In particular, each of the plurality of customer servers 107a and 107b transmits data regarding a particular application to the terminal 103 and the service server 105, or enables the portable terminal 101 to install the particular application for the first time.

More specifically, upon receiving the content registration request message, each of the plurality of customer servers 107a and 107b registers content that has been requested for registration by storing the content in the respective storage associated with customer server 107a or 107b. Each of the customer servers 107a and 107b also creates content for installation including service configuration elements (Service Configs) and content configuration elements (Contents Configs) and transmits the content for installation to the terminal 103. In this regard, the content for installation may be transmitted to the terminal 103 online or offline.

The content for installation refers to content to be used for installing the particular application which includes an install file (install.bat), an uninstall file (uninstall.bat), Application PacKage (APK) files, service configuration element files, content configuration element files, content files, and a customer information file. APK files include installers, launchers, DEs, SDs, and the like, and the customer information file includes a customer ID.

The service configuration element files include customer configuration elements, menu configuration elements, and optional configuration elements. The customer configuration elements include information regarding a particular product (e.g., auto model menu information of a particular auto maker) offered by a corresponding customer server and common menu information that includes information about a menu provided in common to all customers. The menu configuration elements include menu configuration information for configuring a screen of the particular application. The optional configuration elements may also include optional information about e.g., monetary unit and volume, and user interface resource information, such as, for example, main background music. The content configuration elements include configuration information of content that makes up the particular application.

Each of the customer servers 107a and 107b may respectively enable the portable terminal 101 to re-install the particular application by transmitting the service configuration elements and content configuration elements to the portable terminal 101 that is in need of re-installing the particular application.

More specifically, upon reception of the service configuration element message to request service configuration elements to re-install the particular application from the portable terminal 101, each of the customer servers 107a and 107b finds service configuration elements from its storage and transmits the service configuration elements to the portable terminal 101. In addition, upon reception of the content configuration element message to request content configuration elements to re-install the particular application from the portable terminal 101, each of the customer servers 107a and 107b finds content configuration elements from its storage and transmits the content configuration elements to the portable terminal 101.

In addition, each of the customer servers 107a and 107b receives the content configuration element request message that includes portable terminal version information to represent a version of the particular application to be re-installed in the portable terminal 101, and the respective customer server 107, 108 compares the portable terminal version information with customer server version information to represent a version of the particular application offered by the corresponding customer server. If the portable terminal version information is identical to the customer server version information, then each of the customer servers 107a and 107b transmits a first content configuration element reply message that indicates that updates of the content configuration elements are not necessary.

Otherwise, if the portable terminal version information is lower than the customer server version information, each of the respective customer servers 107a and 107b transmits a content version list that includes customer server version information and service-specific content version information in a second content configuration element reply message. The service-specific content version information represents versions of content required to offer a plurality of services provided in a particular application.

Upon reception of the content configuration element request message for services to request content configuration elements required to be updated for services from the portable terminal 101, each of the customer servers 107a and 107b detects content configuration elements requiring an update for services from its storage based on the content configuration element request message for services, and transmits the detected content configuration elements to the portable terminal 101. The content configuration element request message for services includes at least one identifier that represents at least a piece of content required to be updated.

The terminal 103 installs the particular application in the portable terminal 101 for the first time. More specifically, the terminal 103 receives content for installation used to install the particular application from the customer server 107 (any one of the customer servers 107a and 107b). The terminal 103 then transmits a solution to the portable terminal 101 to install the particular application in order for the portable terminal 101 to install the particular application, at the request of a manager of the terminal 103. Here, the solution represents the data for installing the particular application. Therefore, the portable terminal 101 installs the particular application to use the solution. When the install file included in the content for installation is executed by the manager of the terminal 103, the terminal 103 determines that the particular application is requested to be installed.

With continued reference to FIG. 1, the download server 109 re-installs the particular application in the portable terminal 101. More specifically, upon reception of an application download request message to request to download the particular application from the portable terminal 101 while connection to the portable terminal 101, the download server 109 searches for the particular application from among a plurality of applications stored beforehand, and transmits the particular application to the portable terminal 101.

The portable terminal 101 installs the particular application to provide services offered by the customer servers 107a and 107b to the user of the portable terminal 101. Especially, the portable terminal 101 initially installs the particular application by exchanging data related to the particular application with the plurality of customer servers 107a and 107b, the terminal 103, and the service server 105.

More specifically, the portable terminal 101 receives a solution for the particular application from the terminal 103 to install the particular application. The portable terminal 101 installs the particular application based on the solution, detects the portable terminal's ID, and encrypts service configuration elements. The portable terminal 101 creates a first authentication request message that includes the portable terminal's ID and a customer ID that represents a customer server associated with the portable terminal 101, and transmits the first authentication request message to the service server 105.

The portable terminal 101 then receives an authentication reply message from the service server 105 in return for the first authentication request message. The authentication reply message may be a first authentication reply message to represent successful authentication about the portable terminal 101 or a second authentication reply message to represent authentication failure about the portable terminal 101. The portable terminal 101 confirms the authentication result based on the received authentication reply message, and accordingly, runs the particular application or stops installing the particular application.

For example, upon reception of the first authentication reply message, the portable terminal 101 determines that the authentication about the portable terminal 101 was successful and may automatically run the particular application. In another example, upon reception of the second authentication reply message, the portable terminal 101 determines that the authentication about the portable terminal 101 has been failed and may automatically stop installing the particular application.

The portable terminal 101 also re-installs the particular application by exchanging data related to the particular application with the plurality of customer servers 107a and 107b, the download server 109, and the service server 105.

Still with continued reference to FIG. 1, more specifically, the portable terminal 101 displays at least one of a plurality of applications stored in the download server 109 when connected to the download server 109. Furthermore, if a particular application is requested by the user to be downloaded from among the at least one displayed application, the portable terminal 101 creates the application download request message to request to download the particular application and transmits the application download request message to the download server 109.

The portable terminal 101 receives the particular application from the download server 109 in return for sending the application download request message, and automatically installs the received particular application. The portable terminal 101 then creates a second authentication request message, which is to authenticate the portable terminal 101, to request authentication of the portable terminal 101 and transmits the second authentication request message to the service server 105. The second authentication request message includes the portable terminal's 101 ID. The portable terminal 101 receives an authentication reply message in return for the second authentication request message. The authentication reply message may be a first authentication reply message to represent successful authentication of the portable terminal 101 with the newly installed application or a second authentication reply message to represent authentication failure about the portable terminal 101.

The portable terminal 101 then confirms authentication results received from the service server 105 regarding the portable terminal 101 based on the received authentication reply message. If authentication of the portable terminal 101 was successful, the portable terminal 101 may create a service URL request message to request a URL of a customer server that stores content of the particular application, and transmits the service URL request message to the service server 105. The portable terminal 101 receives a service URL reply message including an Internet address of the customer server in return for sending the service URL request message.

The portable terminal 101 detects the Internet address of the customer server from the service URL reply message, and connects to the customer server by accessing the Internet address. The portable terminal 101 also may create a service configuration element request message to request service configuration elements regarding the particular application, and transmits the service configuration element request message to the customer server. The portable terminal 101 receives service configuration elements from the customer server in return for the service configuration element request message, and stores them in a memory.

The portable terminal 101 also creates a content configuration element request message to request content configuration elements, and transmits the content configuration element request message to the customer server. The portable terminal 101 receives content configuration elements from the customer server in return for the content configuration element request message, and stores them.

The content configuration element request message may include portable terminal version information to represent a version of the particular application to be installed within the portable terminal 101. In response, the portable terminal 101 may receive a first content configuration element reply message to represent that updates of content configuration elements are not necessary, or may receive a second content configuration element reply message that includes a content version list having customer server version information and service-specific content version information. The customer server version information refers to information about a version of the particular application offered by the customer server, and the service-specific content version information refers to information about versions of contents required to provide multiple services in the particular application.

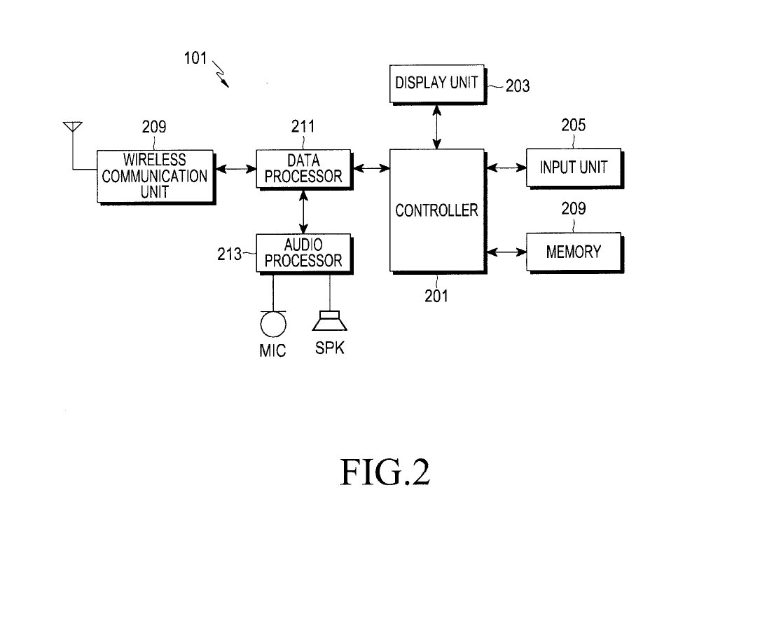

If the second content configuration element reply message is received, a controller 201 (FIG. 2) of the portable terminal 101 compares the service-specific content version information included in the second content configuration element reply message with service-specific content version information about the particular application to be re-installed in the portable terminal 101. Based on the comparison result, the portable terminal 101 finds content versions of services of the particular application which are lower in a version number than content versions of services included in the received service-specific content version information. The portable terminal 101 then creates a content configuration element request message for services that includes information about the checked content versions of services, and transmits the content configuration element request message for services to the customer server. The content configuration element request message for services is a message to request content configuration elements for services in need of being updated.

The portable terminal 101 receives content configuration elements for the particular application from the customer server in return for the content configuration element request message for services, and stores them.

The portable terminal 101 then configures a screen of the particular application based on the stored service configuration elements. The particular application provides a plurality of predetermined sample screens, each of which has a predetermined background screen color and predetermined features, arrangement, and colors of buttons and windows to display content. The service configuration elements include customer configuration elements, menu configuration elements, and optional configuration elements. The menu configuration elements may include an identifier that indicates a sample screen selected by the customer server from among the plurality of sample screens. The portable terminal 101 determines a screen configuration of the particular application by selecting any one of the plurality of sample screens based on the menu configuration elements.

The portable terminal 101 also configures content of the particular application based on the stored content configuration elements. The portable terminal 101 displays the content on the screen of the particular application configured based on the menu configuration elements.

FIG. 2 is a block diagram illustrating a non-limiting configuration of a portable terminal, according to an exemplary embodiment of the present invention.

Referring now to FIG. 2, the portable terminal 101 may include a controller 201, a display unit 203, an input unit 205, a memory 207, a wireless communication unit 209, a data processor 211, and an audio processor 213.

The wireless communication unit 209 includes hardware such as a transceiver, and performs wireless communication functionality of the portable terminal 101. More specifically, the wireless unit 209 can include a transmitter for performing up conversion on the frequency of a signal for transmission and amplifying the signal, and a receiver for performing low-noise amplification on a received signal and performing down conversion on the frequency of the received signal. More than one type of wireless communication may be transmitted and received by the wireless communication unit 209, for example WAP, radio frequency (RF), WLAN, Bluetooth, 802.11, NFC, etc. Still referring to FIG. 2, the data processor 211 includes circuitry such as a transmitter for encoding and modulating the signal to be transmitted, and a receiver for demodulating and decoding the received signal. Here, the data processor 211 may include a modem and a microprocessor, processor, or a codec, and the codec may have a data codec for e.g., packet data processing, or an audio codec for e.g., audio signal processing.

The audio processor 213 includes circuitry (which may be integrated) that reproduces a received audio signal output by the data processor 211 through a speaker, or transmits an audio signal generated by a microphone to the data processor 211 for transmission.

The input unit 205 has virtual or actual keys for entering information of numbers and characters, and function keys for establishing various functionalities, and the display unit 203 displays image signals onto a screen and displays data requested by the controller 201 to be output.

If the display unit 203 is implemented, for example, as a capacitive touchscreen display or a resistive touchscreen display, the input unit 205 may only include a minimum number of preset keys while the display unit 203 may take over some of key input functionalities of the input unit 205. The memory 207 comprises a non-transitory machine readable medium that may include a program memory and a data memory. Here, the program memory stores a booting system and an operating system (hereinafter, referred to as ‘OS’) for controlling general operations of the portable terminal, and the data memory stores various data generated in the operation of the portable terminal.

The controller 201, which may be a processor or microprocessor, is configured to control general operations of the portable terminal. The controller 201 controls installation of a particular application to provide a service offered by any one of the customer servers 107a and 107b to the user of the portable terminal 101.

More specifically, the controller 201 receives a solution for the particular application from the terminal 103 in order to install the particular application for the first time. The portable terminal 101 installs the particular application based on the solution, detects the portable terminal's 101 ID and encrypts service configuration elements among the received solution. That is, the portable terminal detects its own ID. The ID of the portable terminal, for example, is the MAC address. The controller 201 creates a first authentication request message that includes the portable terminal's 101 ID and a customer ID that represents a customer server associated with the portable terminal 101, and transmits the first authentication request message to the service server 105.

The controller 201 receives an authentication reply message from the service server 105 in return for controlling the portable terminal to send the first authentication request message. The authentication reply message may be, for example, a first authentication reply message to represent successful authentication about the portable terminal 101 or a second authentication reply message to represent authentication failure about the portable terminal 101. The controller 201 confirms the authentication result based on reading the received authentication reply message, and accordingly, runs the particular application or stops installing the particular application based on the authentication result.

For example, upon reception by the portable terminal 101 of the first authentication reply message, the controller 201 determines that the authentication of the portable terminal 101 was successful and may automatically run (execute) the particular application. In another example, upon reception of the second authentication reply message, the controller 201 determines that the authentication of the portable terminal 101 has failed and may automatically stop installing the particular application. In addition to or in lieu of stopping the installation of the particular application, the controller may control display of a screen indicating the authentication has failed, and may prompt whether a retry is desired, or it is possible that a retry could be a predetermined action that is attempted an additional time or number of times.

More specifically, the controller 201 controls the display unit 203 to display at least a screen indicating one of a plurality of applications stored in the download server 109 when connected to the download server 109 to re-install the particular application. Furthermore, if the particular application is requested by the user to be downloaded from among the at least one displayed application, the controller 201 creates an application download request message to request to download the particular application and transmits the application download request message to the download server 109.

With continued reference to FIG. 2, the controller 201 receives the particular application from the download server 109 in return for the application download request message, and automatically installs the received particular application. The controller 201 then creates a second authentication request message to request authentication of the portable terminal 101, and transmits the second authentication request message to the service server 105. The second authentication request message includes the portable terminal's 101 ID. The controller 201 receives an authentication reply message in return for the second authentication request message. The authentication reply message may be a first authentication reply message to represent successful authentication of the portable terminal 101 or a second authentication reply message to represent authentication failure about the portable terminal 101.

The controller 201 confirms authentication results regarding the portable terminal 101 based on the received authentication reply message. If authentication of the portable terminal 101 was successful, the controller 201 creates a service URL request message to request an Internet address of a customer server (107a, 107b, for example) that stores content regarding the particular application, and transmits the service URL request message to the service server 105. The controller 201 receives a service URL reply message including the Internet address of the customer server in return for sending the service URL request message.

The controller 201 detects the Internet address of the customer server from the service URL reply message, and controls the portable terminal to connect to the customer server using the detected Internet address. The controller 201 also creates a service configuration element request message to request service configuration elements regarding the particular application, and transmits the service configuration element request message to the customer server. The controller 201 receives service configuration elements from the customer server in return for the service configuration element request message, and stores them.

The controller 201 also controls creation of a content configuration element request message for requesting content configuration elements, and transmits the content configuration element request message to the customer server. The controller 201 receives content configuration elements from the customer server in return for the content configuration element request message, and stores them.

The content configuration element request message may include, for example, portable terminal version information that represents a version of the particular application to be installed within the portable terminal 201. The controller 201 receives a first content configuration element reply message to represent that updates of content configuration elements are not necessary (or not recommended), or receives a second content configuration element reply message that includes a content version list having customer server version information and service-specific content version information. The customer server version information refers to information about a version of a particular application offered by the customer server, and the service-specific content version information refers to information about versions of contents required to provide multiple services in the particular application.

If the second content configuration element reply message is received by the portable terminal, the controller 201 compares the service-specific content version information included in the second content configuration element reply message with service-specific content version information about the particular application to be re-installed in the portable terminal 101. Based on the comparison result, the controller 201 checks whether there are any content versions of services of the particular application, which is (are) lower in version number than content versions of services included in the received service-specific content version information. The controller 201 then creates a content configuration element request message for services that includes information about the checked content versions of services, and transmits the content configuration element request message for services to the customer server. The content configuration element request message for services is a message to request content configuration elements for services in need of being updated.

The controller 201 receives content configuration elements for the particular application from the customer server in return for the content configuration element request message for services, and stores them in a memory.

The controller 201 then configures a screen of the particular application based on the stored service configuration elements. The particular application provides a plurality of predetermined sample screens, each of which has a predetermined background screen color and predetermined features, arrangement, and colors of buttons and windows to display content. The service configuration elements include customer configuration elements, menu configuration elements, and optional configuration elements. The menu configuration elements include an identifier that indicates a sample screen selected by the customer server from among the plurality of sample screens. The portable terminal 101 determines a screen configuration of the particular application by selecting any one of the plurality of sample screens based on the menu configuration elements.

With continued reference to FIG. 2, the controller 201 then configures content of the particular application based on the stored content configuration elements. The controller 201 displays the content in the screen of the particular application configured based on the menu configuration elements.

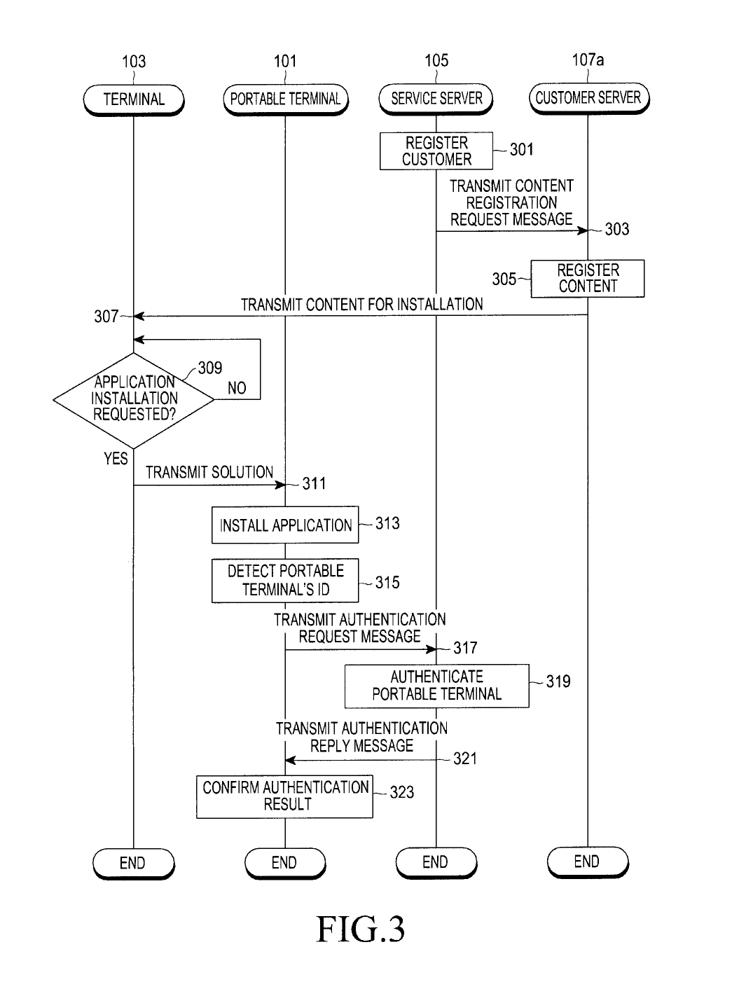

FIG. 3 illustrates one way a sequence of installing a particular application in a communication system can occur, according to an exemplary embodiment of the invention.

Referring now to FIG. 3, at task (301) upon request of a manager of the service server 105 for registration of a customer, the service server 105 creates a storage file, e.g., database for storing data related to the customer and registers the customer by creating the customer's ID to later identify the customer.

At task 303, when one of a plurality of service items that may be provided by the manager of the service server 105 to the customer is selected, the service server 105 determines to provide a service that corresponds to the selected service item.

The service server 105 creates and transmits to one (e.g., the customer server 107a) of a plurality of customer servers 107a and 107b that corresponds to the registered customer a content registration request message to request to register content in a storage of the customer server in task 303.

At task 305, upon receiving the content registration request message from the service server 105, the customer server 107a registers the content when a manager of the customer server 107a stores the requested content in its storage.

At task 307, the customer server 107a creates content for installation that contains service configuration elements and content configuration elements in order to install a particular application based on the registered content and transmits the content for installation to the terminal 103, and proceeds to task 309. The content for installation may be transmitted to the terminal 103 online or offline.

At task 309, the terminal 103 receives from the customer server 107a and stores the content for installation and determines whether the user of the terminal 103 requests installation of the particular application.

If at task 309 the terminal 103 determines that the installation of the particular application is requested, then at task 311 the terminal 103 or otherwise, repeats the task 309. In task 311, the terminal 103 transmits a solution to install the particular application to the portable terminal 101.

At ask 313, the portable terminal 101 receives the solution and installs the particular application based on the solution and then performs task 315.

At task 315, the portable terminal 101 detects (e.g. retrieves, reads) the portable terminal's 101 ID, creates a first authentication request message that includes the portable terminal's 101 ID and a customer ID of a customer associated with the portable terminal 101.

At task 317, the portable terminal 101 transmits the first authentication request message to the service server 105, and proceeds to perform task 319. The portable terminal's 101 ID refers to a unique ID given to the portable terminal 101. For example, the portable terminal's 101 ID may be a MAC address of the portable terminal 101.

The service server 105 receives the first authentication request message, analyzes the first authentication request message to detect the portable terminal's 101 ID and the customer ID, and at task 319 authenticates the portable terminal 101 using the portable terminal's 101 ID and the customer ID, and then proceeds to perform task 321. The service server 105 transmits an authentication reply message that includes an authentication result in task 321, and proceeds to perform task 323.

More specifically, the service server 105 searches the database as shown in Table 1 for at least one portable terminal's ID that corresponds to the customer ID, and determines whether there is one of the searched portable terminals' IDs that is identical to the detected portable terminal's 100 ID. If the service server 105 determines that there is a portable terminal's ID identical to the portable terminal's 100 ID, the service server 105 creates a first authentication reply message that represents successful authentication of the portable terminal 101 and transmits the first authentication reply message to the portable terminal 101. Otherwise, the service server 105 determines that there is no portable terminal's ID that identical to the portable terminal's 100 ID, the service server 105 creates a second authentication reply message that represents authentication failure regarding the portable terminal 101 and transmits it to the portable terminal 101.

In task 323, the portable terminal 101 receives the authentication reply message and confirms the authentication result about the portable terminal 101 based on the received authentication reply message. For example, upon reception of the first authentication reply message, the controller 201 determines that the authentication about the portable terminal 101 was successful and may automatically run the particular application. In another example, upon reception of the second authentication reply message, the controller 201 determines that the authentication of the portable terminal 101 has failed and the controller may automatically stop installing the particular application.

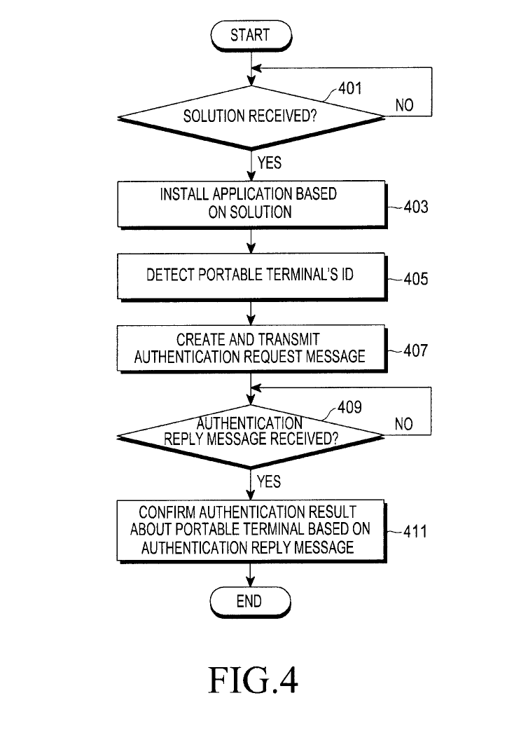

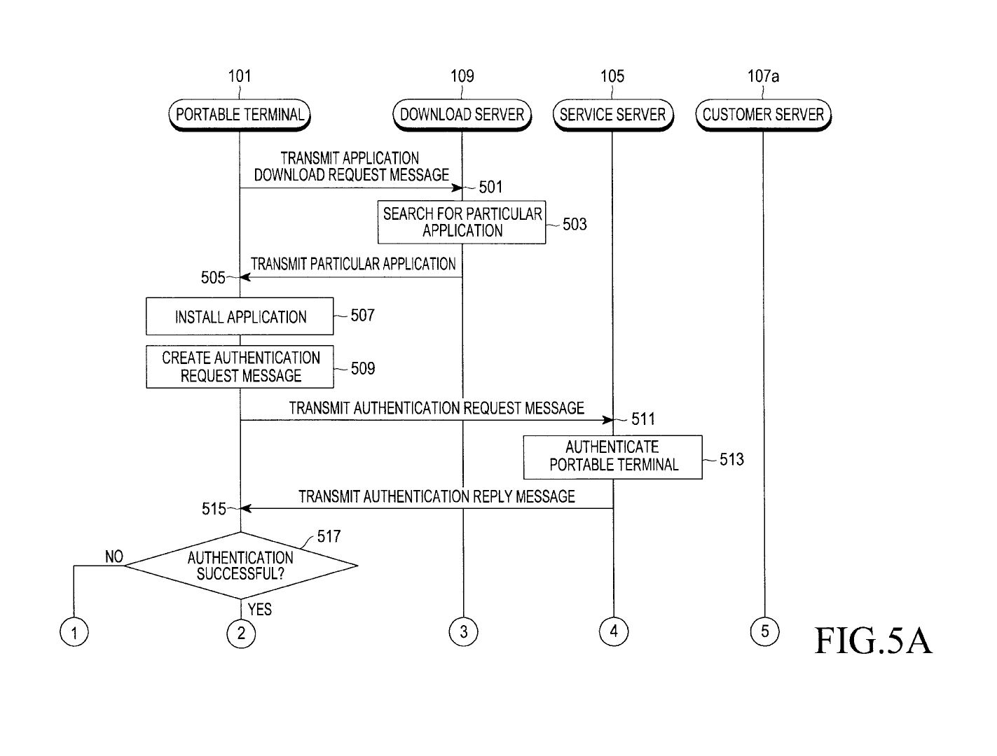

FIG. 4 is a flowchart illustrating operation of a method of installing a particular application in a portable terminal, according to an exemplary embodiment of the invention.

Referring now to FIG. 4, at task 401, the controller 201 of the portable terminal 101 determines whether a solution to install a particular application is received from the terminal 103, at task 401. If the solution is received, the first controller 201 proceeds to task 403, or otherwise, repeats the task 401.

At task 403, the controller 201 installs the particular application based on the solution.

At task 405, the controller 201 detects (e.g. retrieves) the portable terminal's 101 ID.

At task 407, the controller 201 creates a first authentication request message that includes the portable terminal's 101 ID and a customer ID of a customer associated with the portable terminal 101 and transmits the first authentication request message to the service server 105.

The portable terminal's 101 ID refers to a unique ID given to the portable terminal 101. For example, the portable terminal's 101 ID may be a MAC address of the portable terminal 101.

At task 409, the controller 201 receives the authentication reply message from the service server 105 and at task 411 confirms the authentication result regarding the portable terminal 101 based on the received authentication reply message. For example, upon reception of the first authentication reply message, the controller 201 determines that the authentication about the portable terminal 101 was successful and may automatically run the particular application. In another example, upon reception of the second authentication reply message, the controller 201 determines that the authentication regarding the portable terminal 101 has failed and may automatically stop installing the particular application.

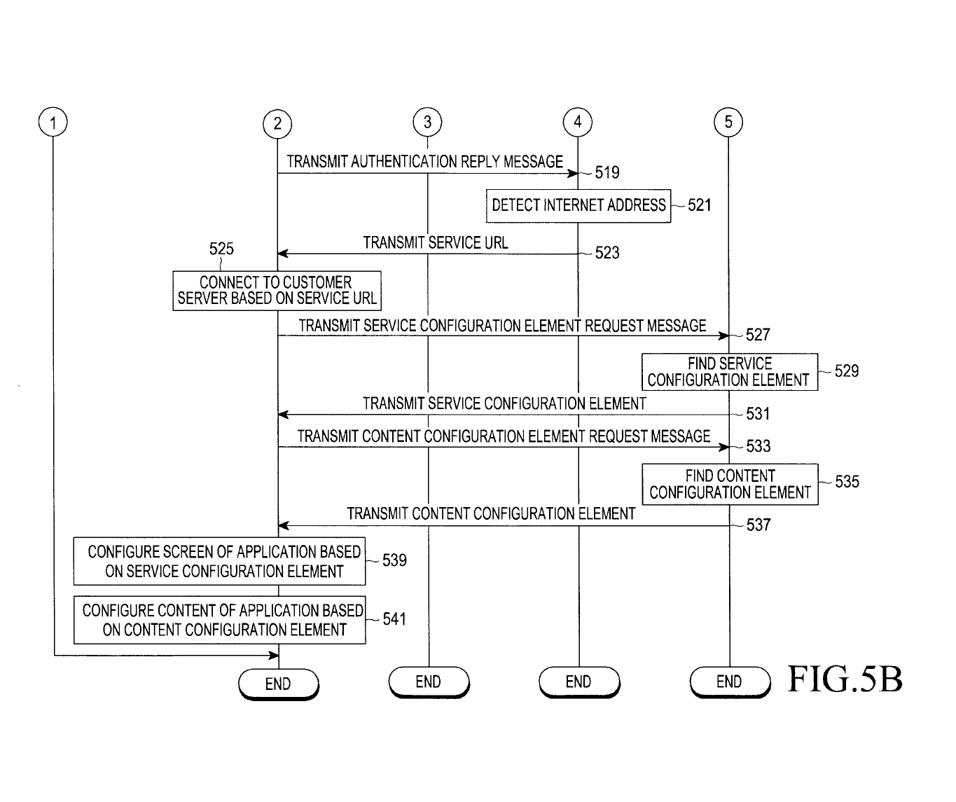

FIGS. 5A and 5B illustrate operation of a sequence of re-installing a particular application in a communication system, according to an exemplary embodiment of the invention.

Referring now to FIGS. 5A and 5B, at task 501, the portable terminal 101 displays a list containing at least one of a plurality of applications stored in the download server 109 when connected to the download server 109. Furthermore, if a particular application is requested by the user to be downloaded from among the at least one displayed application, the portable terminal 101 creates an application download request message to request to download the particular application and transmits the application download request message to the download server 109, and proceeds to task 503.

At task 502, upon reception of the application download request message, the download server 109 searches for the particular application from among a plurality of applications.

At task 505, the download server 109 transmits the searched particular application to the portable terminal 101 and proceeds to task 507.

At task 507, the portable terminal 101 receives the particular application transmitted at task 505 and at task 507 automatically installs the particular application.

At task 509, the portable terminal 101 detects (e.g. retrieves) the portable terminal's ID and creates a second authentication request message that includes the portable terminal's ID.

At task 511, the portable terminal 101 transmits the second authentication request message to request authentication about the portable terminal 101 to the service server 105.

At task 513, the service server 105 receives the second authentication request message, analyzes the second authentication request message to detect the portable terminal's 101 ID, and authenticates the portable terminal 101 based on the portable terminal's 101 ID.

More specifically, at task 513, in order to authenticate the portable terminal 101, the service server 105 searches the database as shown in Table 1 for at least one portable terminal's ID, and determines whether there is any searched portable terminal's ID that is identical to the detected portable terminal's 100 ID. If the service server 105 determines that there is a portable terminal's ID identical to the portable terminal's 100 ID, the service server 105 creates a first authentication reply message that represents successful authentication and transmits it to the portable terminal 101. Otherwise, if the service server 105 determines that there is no portable terminal's ID identical to the portable terminal's 100 ID, the service server 105 creates a second authentication reply message that represents authentication failure and A task 515, the service server 105 transmits an authentication reply message that includes an authentication result to the portable terminal 101 the reply message indicating either successful authentication or failure.

At task 517, the portable terminal 101 receives the authentication reply message and determines whether the authentication about the portable terminal 101 was successful based on the received authentication reply message. If the portable terminal determines from the reply message that the authentication regarding the portable terminal 101 was successful, the portable terminal 101 either performs task 519, or else stops installing the particular application. The portable terminal 101 creates a service URL request message to request the URL of a customer server (e.g., the customer server 107a) associated with the portable terminal 101 that stores content about the particular application and transmits the service URL request message to the service server 105 at task 519.

At task 521, the service server 105 receives the service URL request message and detects the Internet address of the customer server 107a from the database as shown in Table 1.

At task 523, the service server 105 creates a service URL reply message that includes the detected Internet address of the customer server 107a and transmits the service URL reply message to the portable terminal 101.

At task 525, the portable terminal 101 then receives the service URL reply message, analyzes the service URL reply message to detect the Internet address of the customer server 107a, and connects to the customer server 107a with the Internet address.

At task 527, the portable terminal 101 creates a service configuration element request message to request service configuration elements regarding the particular application, and transmits the service configuration element request message to the customer server 107a.

At task 529, the customer server 107a then receives the service configuration element request message and finds service configuration elements regarding the particular application in a storage of the customer server 107a.

At task 531, the customer server 107a transmits the service configuration elements to the portable terminal 101.

The portable terminal 101 then receives and stores the service configuration elements received at task 531.

At task 533, the portable terminal creates a content configuration element request message to request content configuration elements regarding the particular application, and transmits the content configuration element request message to the customer server 107a.

At task 535, the customer server 107a then receives the content configuration element request message and finds content configuration elements regarding the particular application in the storage of the customer server 107a, transmits the content configuration elements to the portable terminal 101 in task 537, and proceeds to task 539.

The content configuration element request message includes portable terminal version information that indicates a version of the content regarding the particular application to be installed in the portable terminal 101. The customer server 107a then compares the portable terminal version information with customer server version information that indicates a version of the content regarding the particular application offered by the customer server 107a. If the portable terminal version information is identical to the customer server version information, the customer server 107a transmits a first content configuration element reply message that represents updates of the content configuration elements are not necessary.

Otherwise, if the portable terminal version information is lower in a numerical value or sequence than the current customer server version information, the customer server 107a transmits a content version list that includes customer server version information and service-specific content version information in a second content configuration element reply message. The service-specific content version information represents versions of contents required to offer a plurality of services provided in a particular application.

Upon reception of the second content configuration element reply message, the portable terminal 101 compares the service-specific content version information included in the second content configuration element reply message with service-specific content version information about the particular application to be installed in the portable terminal 101. Based on the comparison result, the portable terminal 101 may find content versions of services of the particular application which are may be lower than content versions of services included in the received service-specific content version information. The portable terminal 101 then creates a content configuration element request message for services that includes information about the checked content version(s) of services, and transmits the content configuration element request message for a service to the customer server. The content configuration element request message for services is a message to request content configuration elements for services in need of being updated.

The customer server 107a receives the content configuration element request message from the portable terminal 101, detects (e.g. finds) content configuration elements required to be updated for services from among content configuration elements stored in the storage of the customer server 107a based on the received content configuration element request message for services, and transmits the detected content configuration elements to the portable terminal 101.

At 539, the portable terminal 101 then receives and stores the content configuration elements and configures a screen of the particular application based on the service configuration elements. With further regard to task 539, the particular application provides a plurality of predetermined sample screens, each of which has a predetermined background screen color and predetermined features, arrangement, and colors of buttons and windows to display content. The service configuration elements include customer configuration elements, menu configuration elements, and optional configuration elements. The menu configuration elements include an identifier that indicates a sample screen selected by the customer server from among the plurality of sampling screens. The portable terminal 101 determines the screen configuration of the particular application by selecting any one of the plurality of sample screens based on an identifier included in the menu configuration elements.

With continued reference to FIG. 5B, at task 541, the portable terminal 101 then configures content of the particular application based on the stored content configuration elements. The portable terminal 101 displays the content on the screen of the particular application configured based on the menu configuration elements.

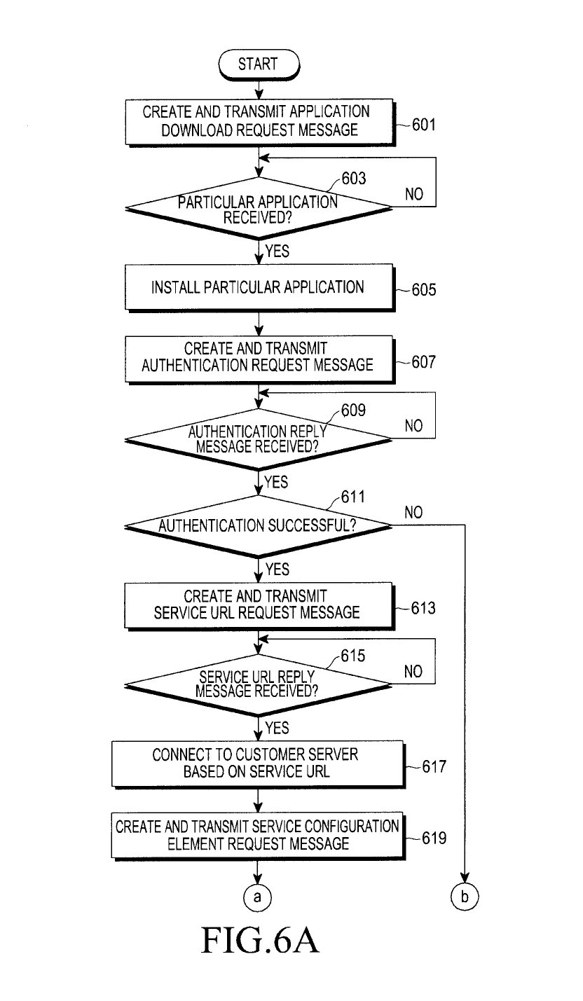

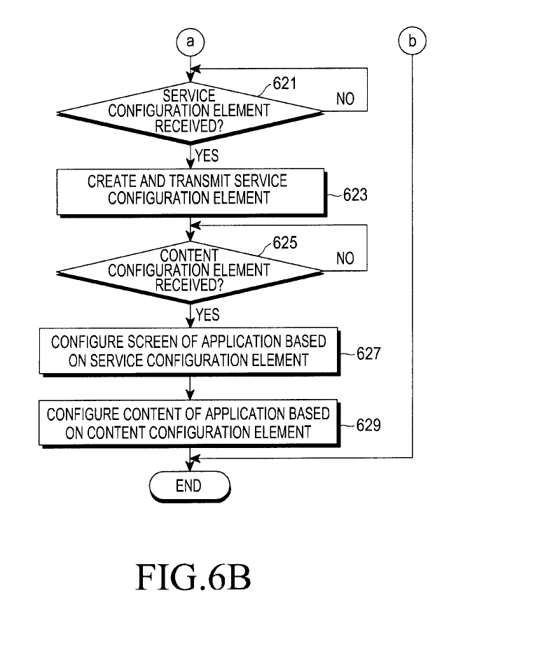

FIGS. 6A and 6B are flowcharts illustrating operation of a method of re-installing a particular application in a portable terminal, according to an exemplary embodiment of the invention.

Referring now to FIGS. 6A and 6B, at task 601 the portable terminal 101 displays at least one of a plurality of applications stored in the download server 109 when connected to the download server 109. Furthermore, if a particular application is requested by the user to be downloaded from among at least one displayed application, the controller 201 creates an application download request message to request to download the particular application and transmits the application download request message to the download server 109, and proceeds to task 603.

In task 603, the controller 201 determines whether the particular application is received from the download server 109 in return for the application download request message. If the particular application is received, the controller 201 can performs task 605, or otherwise, repeats the task 603 if the particular application is not received.

At task 605, the controller 201 automatically installs the received particular application

At task 607, the controller 201 detects the portable terminal's ID, creates a second authentication request message that includes the detected portable terminal's ID, and transmits the second authentication request message to the service server 105.

At task 609, the controller 201 determines whether an authentication reply message is received from the service server 105 in return for the second authentication request message. If at task 609 the authentication reply message is received, the controller 201 will then perform task 611, or otherwise, repeats the task 609 when the message is not received.

At task 611, the controller 201 determines whether the authentication about the portable terminal 101 was successful based on the received authentication reply message. If the controller 201 has determined that the authentication about the portable terminal 101 was successful, the controller 201 will perform task 613, or else stops re-installing the particular application.

At task 613, the controller 201 creates a service URL request message to request the URL of a customer server (e.g., the customer server 107a) associated with the portable terminal 101 that stores content about the particular application and transmits the service URL request message to the service server 105.

At task 615, the controller 201 determines whether a service URL reply message including the Internet address of the customer server 107a is received. If the service URL reply message is received, the controller 201 proceeds to task 617, or otherwise, repeats the task 615.

At task 617, the controller 201 analyzes the received service URL reply message to detect the Internet address of the customer server 107a, and connects to the customer server 107a with the Internet address.

At task 619, the controller 201 creates a service configuration element request message to request service configuration elements regarding the particular application, and transmits the service configuration element request message to the customer server 107a.

In task 621, the controller 201 determines whether the service configuration elements regarding the particular application are received. If the service configuration elements are received, the controller 201 proceeds to perform task 623, or otherwise, repeats the task 621. The controller 201 stores the received service configuration elements, creates a content configuration element request message to request content configuration elements regarding the particular application, and transmits the content configuration element request message to the customer server 107a.

At task 625, the controller 201 determines whether the content configuration elements regarding the particular application are received. Upon reception of a second content configuration element reply message in return for the content configuration element request message, the controller 201 compares the service-specific content version information included in the second content configuration element reply message with service-specific content version information about the particular application to be installed in the portable terminal 101. Based on the comparison result, the controller 201 checks any of content versions of services of the particular application, which is (are) lower than content versions of services included in the received service-specific content version information. The controller 201 then creates a content configuration element request message for services that includes information about the checked content versions of services, and transmits the content configuration element request message for services to the customer server 107a. The controller 201 then receives content configuration elements in return for the content configuration element request message for services.

If the content configuration elements are received, the controller 201 proceeds to perform task 627, or otherwise, repeats task 625.

At task 627, the controller 201 then receives and stores the content configuration elements and configures a screen of the particular application based on the service configuration elements.

The particular application provides a plurality of predetermined sample screens, each of which has a predetermined background screen color and predetermined features, arrangement, and colors of buttons and windows to display content. The service configuration elements include customer configuration elements, menu configuration elements, and optional configuration elements. The menu configuration elements include an identifier that indicates a sample screen selected by the customer server 107a from among the plurality of sampling screens. The controller 201 determines the screen configuration of the particular application by selecting any one of the plurality of sample screens based on the identifier included in the menu configuration elements.

At task 629, the controller 201 then configures content of the particular application based on the stored content configuration elements. The controller 201 displays the content in the screen of the particular application configured based on the menu configuration elements.

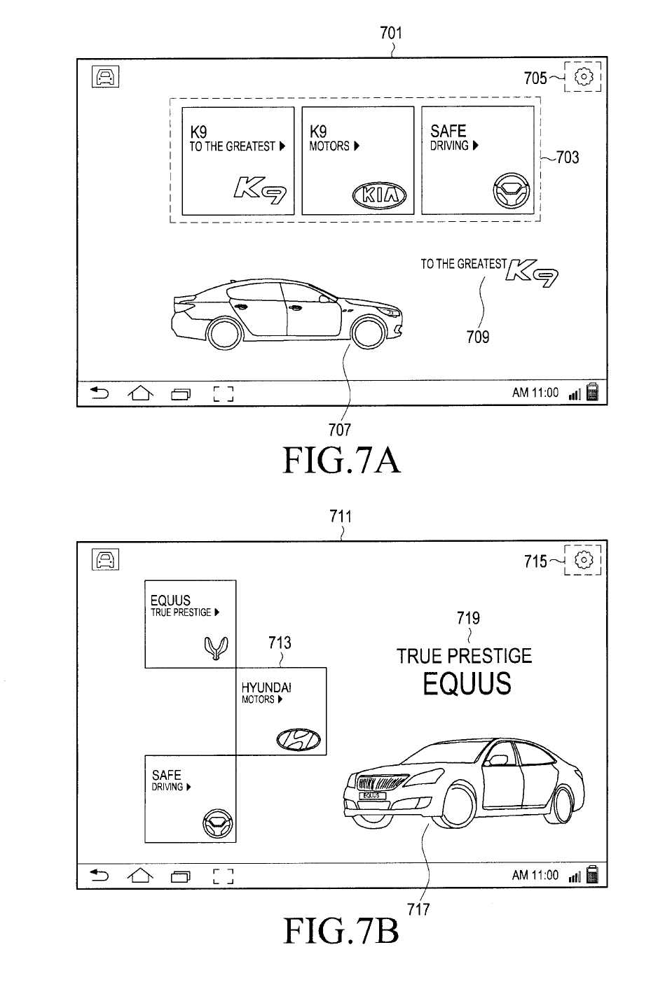

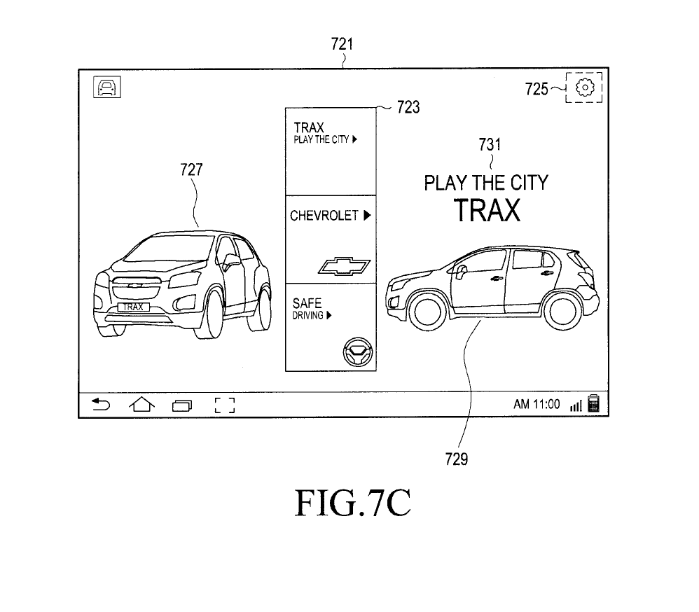

FIGS. 7A, 7B and 7C illustrate screen shots of a particular application in a portable terminal, according to an exemplary embodiment of the invention.

The portable terminal 101 receives service configuration elements from a corresponding customer server associated with the portable terminal 101, detects menu configuration elements from the received service configuration elements, and detects an identifier included in the detected menu configuration elements. The identifier refers to a sample screen selected by the customer server from among a plurality of sample screens provided by the particular application. The portable terminal 101 selects a sample screen that matches the detected identifier from among a plurality of sample screens, and determines the selected sample screen as the screen of the particular application.

For example, assuming that the particular application is a specific auto management application, with reference to FIG. 7A the customer server is a server operated by KIA Motors®, and the customer server selects a first sample screen from among a plurality of sample screens provided by the particular application, the portable terminal 101 receives from the customer server service configuration elements that include menu configuration elements having a first identifier that corresponds to the first sample screen, determines the first sample screen as the screen of the particular application, and may display the screen, such as a screen 701. The first sample screen has a main menu placed on its top center part, a setting menu placed on its top right part, and a car image and name of the user of the portable terminal 101 placed on its bottom center.

As shown in FIG. 7A, the portable terminal 101 may display a main menu 703 in the top center of the screen, a setting menu 705 in the top right of the screen, and a car image 707 and name 709 of the user in the bottom center of the screen, as shown in the screen 701. The main menu 703 consists of a car name, an auto maker's name, and safe driving. The car name is a menu to show information about the user's car or a car manipulation description and manage maintenance and refueling histories; the auto maker's name is a menu to show a new-car information or car news and magazines and provide a contact and location of a customer center; and the safe driving is a menu to give various contextual tips for driving and provide how to respond to accidents or troubles.

As another example, assuming that the particular application is a specific auto management application, as shown in FIG. 7B the customer server is a server operated by HYUNDAI Motors®, and the customer server selects a second sample screen from among a plurality of sample screens provided by the particular application, the portable terminal 101 receives from the customer server service configuration elements that include menu configuration elements having a second identifier that corresponds to the second sample screen, determines the second sample screen as the screen of the particular application, and may display the screen, such as a screen 711. The second sample screen has a main menu placed on its left part, a setting menu placed on its top right part, and a car image and name of the user of the portable terminal 101 placed on its right part.

Accordingly, the portable terminal 101 may display a main menu 713 in the left of the screen, a setting menu 715 in the top right of the screen, and a car image 717 and name 719 of the user in the right of the screen, as shown in the screen 711.

As another example, assuming that the particular application is a specific auto management application, as shown in FIG. 7C the customer server is a server operated by Korea GM Motors®, and the customer server selects a third sample screen from among a plurality of sample screens provided by the particular application, the portable terminal 101 receives from the customer server service configuration elements that include menu configuration elements having a third identifier that corresponds to the third sample screen, determines the third sample screen as the screen of the particular application, and may display the screen, such as a screen 721. The third sample screen has a main menu placed on its center part, a setting menu placed on its top right part, and car images and name of the user of the portable terminal 101 placed on its left and right parts.

Accordingly, the portable terminal 101 may display a main menu 723 in the center of the screen, a setting menu 725 in the top right of the screen, and car images 727 and 729 and name 731 of the user in the left and right of the screen, as shown in the screen 721.

As such, the portable terminal 101 may provide the user with a particular application that provides different screen configurations for different customers.

According to the embodiments of the present invention, different screen configurations for different manufacturers may be provided in an application of a portable terminal. Furthermore, a different screen configuration for each manufacturer may be provided using an identifier of a screen configuration preferred by the manufacturer.

The above-described methods according to the present invention can be implemented in hardware, firmware or as software or computer code that is stored on a non-transitory machine readable medium such as a CD ROM, a RAM, a floppy disk, a hard disk, or a magneto-optical disk or computer code downloaded over a network originally stored on a remote recording medium or a non-transitory machine readable medium and stored on a local non-transitory recording medium, so that the methods described herein are loaded into hardware such as a general purpose computer, or a special processor or in programmable or dedicated hardware, such as an ASIC or FPGA. As would be understood in the art, the computer, the processor, microprocessor controller, or the programmable hardware contain circuitry that may be integrated, and can include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “controller”, “processor” or “microprocessor” constitute hardware in the claimed invention. Under the broadest reasonable interpretation, the appended claims constitute statutory subject matter in compliance with 35 U.S.C. §101 and none of the elements constitute of software per se.

The terms “unit” or “module” as may be used herein is to be understood as constituting or operating in conjunction with hardware such as a circuit, integrated circuit, processor or microprocessor configured for a certain desired functionality in accordance with statutory subject matter under 35 U.S.C. §101, and such terms do not constitute software per se.

The method of providing a particular application in a portable terminal according to the exemplary embodiments of the invention may be embodied as computer-readable codes on a computer-readable recording medium that are loaded into hardware such as a microprocessor or processor and executed. The computer-readable recording medium is any data storage device that can store data which can be thereafter read by a computer system. Examples of the computer readable recording medium include read-only memory (ROM), random-access memory (RAM), Compact Disc (CD)-ROMs, magnetic tapes, floppy disks, optical data storage devices, etc. The computer readable recording medium can also be distributed over network coupled computer systems so that the computer readable code is stored and executed in a distributed fashion.

Several embodiments have been described in connection with e.g., mobile communication terminals, but a person of ordinary skill in the art will understand and appreciate that various modifications can be made without departing the scope of the present invention. Thus, it will be apparent to those ordinary skilled in the art that the invention is not limited to the embodiments described, which have been provided only for illustrative purposes. Although, the previous description has thus been described that a screen of a particular application is configured to be a screen requested by a customer server when the particular application is to be re-installed, the screen of the particular application may be configured to be the screen requested by the customer server even when the particular application is to be updated.

What is claimed is:

1. An apparatus for providing an application in a portable terminal, the apparatus comprising:
a wireless communication unit including a transceiver; and
a controller for controlling the wireless communication unit that receives an identifier that is associated with a screen configuration of a particular application from a server in which the identifier corresponds to the portable terminal, controlling selection of a sample screen from among a plurality of sample screens provided by the particular application based on the received identifier, and controlling configuration of a display screen of the particular application based on the selected sample screen.

2. The apparatus of claim 1, wherein the controller controls installation, re-installation and updating of the particular application.

3. The apparatus of claim 2, wherein the wireless communication unit communicates with the server to receive authentication of the installation, re-installation and updating of the particular application.

4. The apparatus of claim 1, wherein the screen configuration of the particular application associated with the identifier includes at least one of colors of a background screen, shapes, positions, and colors of windows, and shapes, positions, and colors of buttons.

5. The apparatus of claim 1, wherein the identifier associated with a screen configuration of a particular application corresponds with any one of the plurality of sample screens.

6. The apparatus of claim 1, wherein the controller receives via the wireless communication unit the identifier in response to re-installing the particular application.

7. The apparatus of claim 1, wherein the controller receives via the wireless communication unit the identifier in response to updating the particular application.

8. The apparatus of claim 1, wherein the controller receives from the server, via the wireless communication unit, content configuration elements that configure content regarding the particular application.

9. A method for providing an application in a portable terminal, the method comprising:
receiving via a wireless communication unit of the portable terminal an identifier that represents a screen configuration of a particular application from a server that corresponds to the portable terminal;
selecting by a controller of the portable terminal a sample screen from among a plurality of sample screens provided by the particular application based on the received identifier; and
configuring by the controller a screen of the particular application based on the selected sample screen.

10. The method of claim 9, wherein the screen configuration includes at least one of colors of a background screen, shapes, positions, and colors of windows, and shapes, positions, and colors of buttons.

11. The method of claim 10, further comprising displaying by a display unit a screen having the configuration configured by the controller.

12. The method of claim 9, wherein the identifier corresponds to any one of the plurality of sample screens associated with the particular application.

13. The method of claim 9, wherein receiving the identifier comprises receiving the identifier in response to re-installing the particular application.

14. The method of claim 9, wherein receiving the identifier comprises receiving the identifier in response to updating the particular application.

15. The method of claim 9, further comprising: receiving from the server content configuration elements to configure content regarding the particular application.

16. A system for providing an application in a portable terminal, including:
a portable terminal comprising a wireless communication unit including a transceiver and a controller for controlling the wireless communication unit that;
a server in response to a request from the portable terminal, authenticates an identifier received from the portable terminal that is associated with a screen configuration of a particular application of the portable terminal,
wherein the portable terminal controlling selection of a sample screen from among a plurality of sample screens provided by the particular application based on the received identifier, and controlling configuration of a display screen of the particular application based on the selected sample screen.

17. The system according to claim 16, wherein the portable terminal receives an authentication reply message that confirms authentication of the portable terminal.

18. The system according to claim 16, wherein the portable terminal receives an authentication reply message that indicate authentication of the portable terminal has failed.

19. The system of claim 18, wherein the portable terminal automatically stops installation of the particular application upon receiving the authentication reply message indicating that authentication of the portable terminal has failed.
